(19) United States
(12) Patent Application Publication
(10) Pub. No.: US 2024/0120960 A1
(43) Pub. Date: Apr. 11, 2024

(54) GRIP FOR A MOBILE COMMUNICATION DEVICE

(71) Applicant: Frank S. Ferrantello, Monteverde, FL (US)

(72) Inventor: Frank S. Ferrantello, Monteverde, FL (US)

(21) Appl. No.: 18/369,807

(22) Filed: Sep. 18, 2023

Related U.S. Application Data
(63) Continuation-in-part of application No. 17/676,453, filed on Feb. 21, 2022, now Pat. No. 11,791,857.
Application No. 17/676,453 is a continuation of application No. 16/991,246, filed on Aug. 12, 2020, now Pat. No. 11,290,142.
(60) Provisional application No. 63/439,071, filed on Jan. 13, 2023.

(51) Int. Cl. H04B 1/3888

(52) U.S. Cl. CPC H04B 1/3888

(57) ABSTRACT

A device may include a base configured to be coupled to a mobile communication device, a handle comprising a grip and a shaft, and a plurality of anchors that includes a first-end anchor, a second-end anchor and a middle anchor. The base may have a detent mechanism. The shaft may be characterized by (i) a longitudinal handle axis, (ii) a first portion having a first diameter, (iii) a second portion having a second diameter that is different than the first diameter, and (iv) at least one recess configured to be releasably engaged with the detent mechanism. The first-end anchor, second-end anchor and middle anchor may have, respectively, a first channel, a second channel and a middle channel—which may accommodate the shaft and allow it to be slidably translated along and rotated about the longitudinal anchor axis and longitudinal handle axis.

### CROSS-REFERENCE TO RELATED APPLICATIONS

This application is a continuation-in-part of U.S. application Ser. No. 17/676,453, titled “Grip for a Mobile Communication Device, filed Feb. 21, 2022, which is a continuation of U.S. application Ser. No. 16/991,246, titled “Grip for a Mobile Communication Device,” filed on Aug. 12, 2020, now U.S. Pat. No. 11,290,142. This application further claims priority to U.S. Provisional Application Ser. No. 63/439,071, titled “Grip for a Mobile Communication Device,” filed Jan. 13, 2023. This application incorporates the entire contents of the foregoing applications herein by reference.

### TECHNICAL FIELD

Various embodiments relate generally to mobile communication devices, and more particularly to an apparatus for supporting a mobile communication device.

### BACKGROUND

Mobile communication devices are popular worldwide, and there is an increasing need for secure and ergonomic handheld control of these devices, particularly those that incorporate smartphone device technology. Smartphone device technology typically leverages a touch screen interface and provides Internet access and an operating system capable of executing downloaded applications, including, for example, digital identification applications, applications relating to management of assets, payment applications, and digital currency applications—all of which increase the functionality and need for personal security of the devices. As users increasingly rely on such devices, it may be increasingly important for users to be able to securely and comfortably hold and operate such devices.

### SUMMARY

In some embodiments, a device includes a base configured to be coupled to a mobile communication device, a handle comprising a grip and a shaft, and a plurality of anchors. The base may have a detent mechanism. The shaft may be characterized by (i) a longitudinal handle axis, (ii) a first portion having a first diameter, (iii) a second portion having a second diameter that is different than the first diameter, and (iv) at least one recess configured to be releasably engaged with the detent mechanism.

The plurality of anchors may include a first-end anchor, a second-end anchor and a middle anchor. The first-end anchor may have a first channel that accommodates the first diameter, the second-end anchor may have a second channel that accommodates the second diameter, and the middle anchor may have a middle channel. Each of the first channel, second channel and middle channel may be coaxial with a longitudinal anchor axis.

The first channel, second channel and middle channel may accommodate the shaft and allow it to be slidably translated along and rotated about the longitudinal anchor axis and longitudinal handle axis between a first orientation, in which the handle and grip are rotated flush with the base; and a second orientation that is different than the first orientation, in which the handle and grip are releasably fixed, through engagement of the detent mechanism and the at least one recess, at an angle relative to the base.

In some embodiments, the first diameter is greater than the second diameter, and the second-end channel accommodates the second diameter but not the first diameter. The middle channel may comprise two segments, including a first segment that accommodates the first diameter and a second segment that accommodates the second diameter but not the first diameter.

The device may further include a cap configured to be inserted into an end of the first channel, such that when the shaft is disposed in the first channel, middle channel and second channel, and the cap is inserted into the end of the first channel, the cap prevents translation of the shaft away from the middle anchor and past the cap.

The device may further include a plurality of recesses disposed along a common circumference that is also common to the at least one recess. Each of the recesses in the plurality of recesses may be configured to be releasably engaged with the detent mechanism to releasably lock the handle and grip at a corresponding plurality of angles relative to the base. The handle may be selectively fixed at an angle relative to the base to form a stand. The handle may rotate or swivel.

The device may further include at least one additional recess disposed away from the plurality of recesses and also configured to be releasably engaged with the detent mechanism to releasably lock the handle and grip at an angle relative to the base when the grip and handle are translated away from the first-end anchor such that the shaft is retained only by the middle anchor and the second-end anchor.

The device may further include a recessed channel coupling the at least one recess and the at least one additional recess. The recessed channel may be shaped substantially as a longitudinal segment of a cylinder.

The detent mechanism may include an interlocking element disposed on a spring member, wherein the spring member biases the interlocking element toward the longitudinal anchor axis. The detent mechanism may include a magnet. The interlocking element may be a hemispherical element; and the at least one recess may be a hemispherical recess configured to engage with the hemispherical element.

The grip may include four finger openings disposed adjacent to each other. The grip may further include a palm opening between the four finger openings and the shaft. The device may further include an insert that is configured to close the palm opening. The insert may be removably attached to the grip.

The base may include a case for the mobile communication device or a surface having an adhesive configured to adhere to a portion of the mobile communication device. The base may include a wallet that is configured to retain business cards, credit cards or identification cards.

In some embodiments, a device includes a base configured to be coupled to a mobile communication device, a handle comprising a grip and a shaft, and a plurality of anchors. The base may have a detent mechanism, or it may omit such a detent mechanism. The shaft may be characterized by (i) a longitudinal handle axis, (ii) a first portion having a first diameter, (iii) a second portion having a second diameter that is different than the first diameter, and (iv) at least one recess configured to be releasably engaged with the detent mechanism.

The plurality of anchors may include a first-end anchor, a second-end anchor and a middle anchor. The first-end anchor may have a first channel that accommodates the first diameter, the second-end anchor may have a second channel that accommodates the second diameter, and the middle anchor may have a middle channel. Each of the first channel, second channel and middle channel may be coaxial with a longitudinal anchor axis.

The first channel, second channel and middle channel may accommodate the shaft and allow it to be slidably translated along and rotated about the longitudinal anchor axis and longitudinal handle axis. The grip may include four finger openings disposed adjacent to each other and a palm opening between the four finger openings and the shaft.

The device may include an insert that is configured to close the palm opening. The detent mechanism may include an interlocking element disposed on a spring member, wherein the spring member biases the interlocking element toward the longitudinal anchor axis.

### BRIEF DESCRIPTION OF THE DRAWINGS

FIG. 1 is a perspective view of components of one embodiment of a device.

FIG. 2 is a perspective view of the components shown in FIG. 1.

FIG. 3 is a perspective view of the components shown in FIG. 1.

FIGS. 4A and 4B are perspective views of components of one embodiment of a device.

FIG. 5 is a perspective view of components of one embodiment of a device.

FIG. 6 is a perspective view of components of one embodiment of a device.

FIGS. 7A-7D illustrate another exemplary embodiment of a device.

FIG. 8A is a side view of another exemplary embodiment of a device.

FIG. 8B illustrates radial cross-sections of the exemplary device shown in FIG. 8A.

FIG. 8C is an enlarged view of portions of the radial cross-sections shown in FIG. 8B.

FIGS. 8D-8G are longitudinal sections of the device shown in FIG. 8A, with the handle at various positions relative to the base.

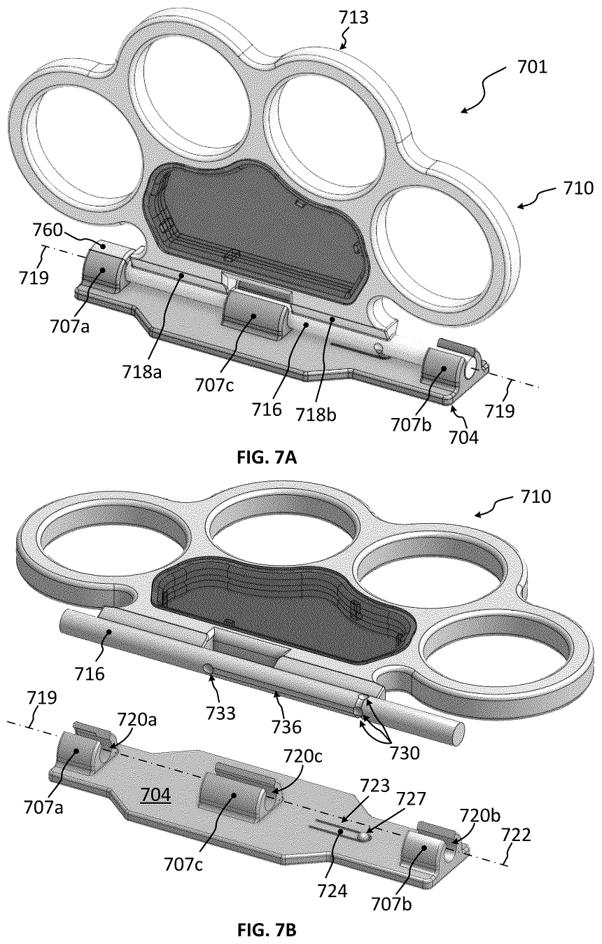

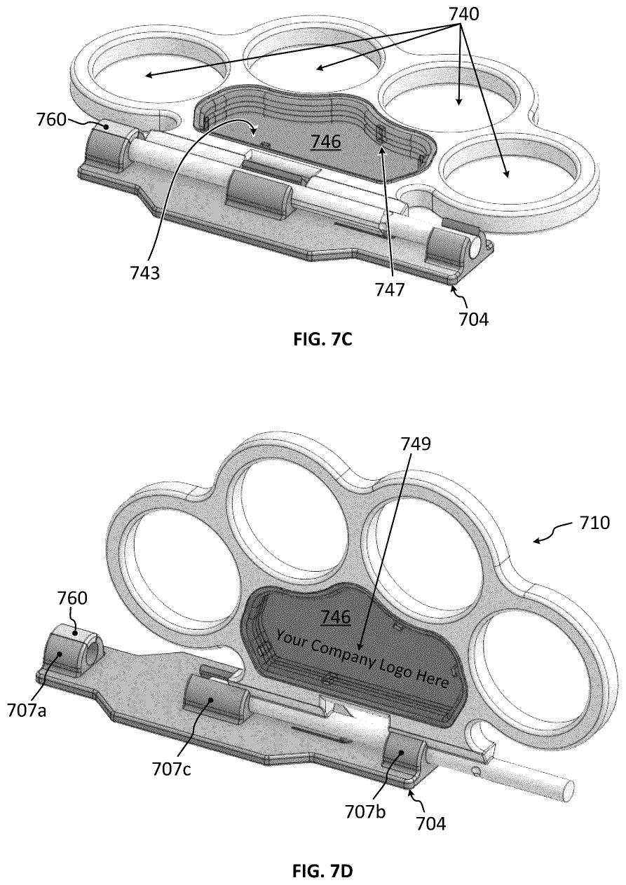

FIGS. 7A-7D illustrate another exemplary embodiment of a device.

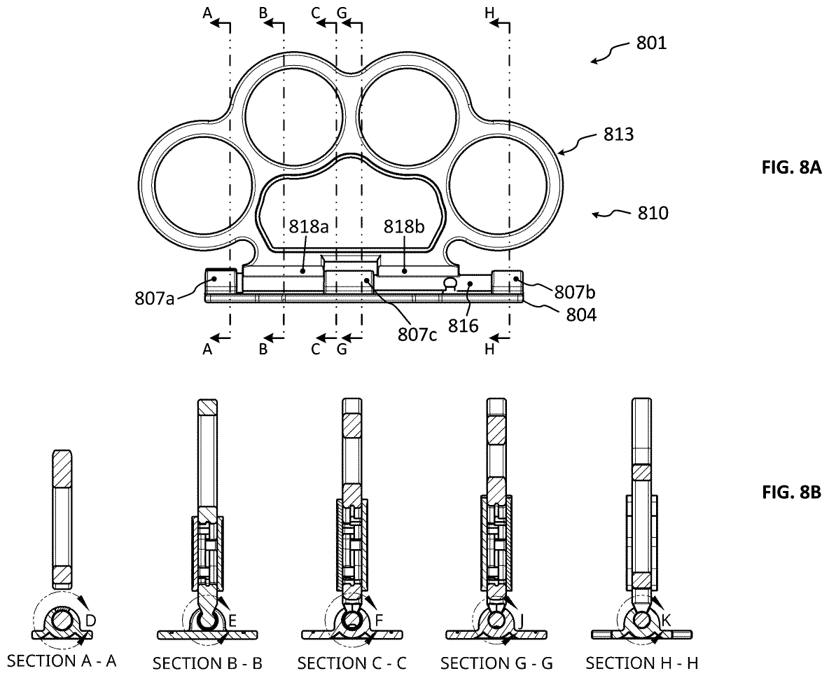

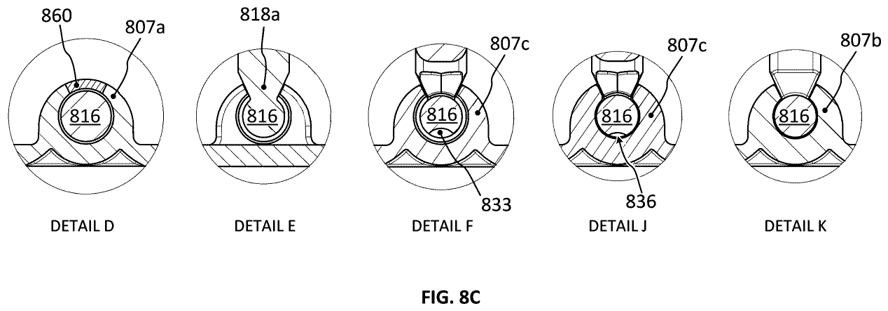

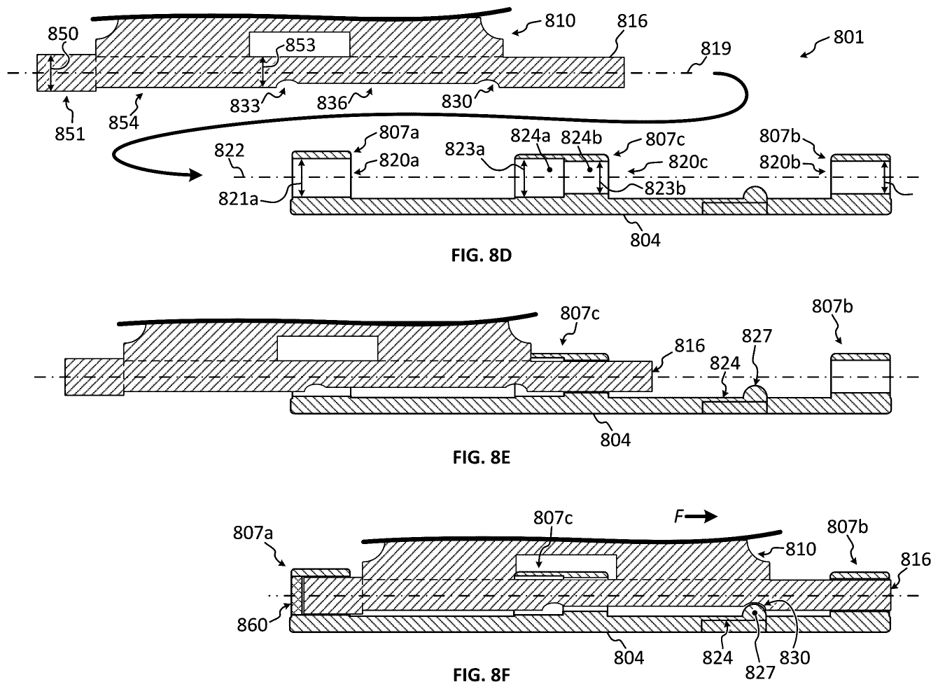

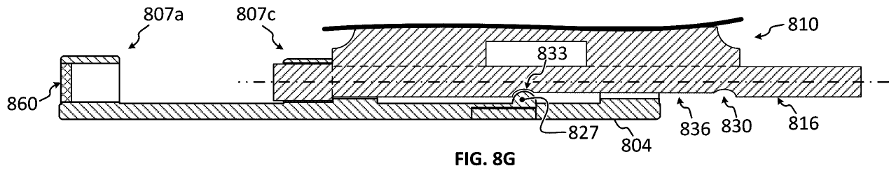

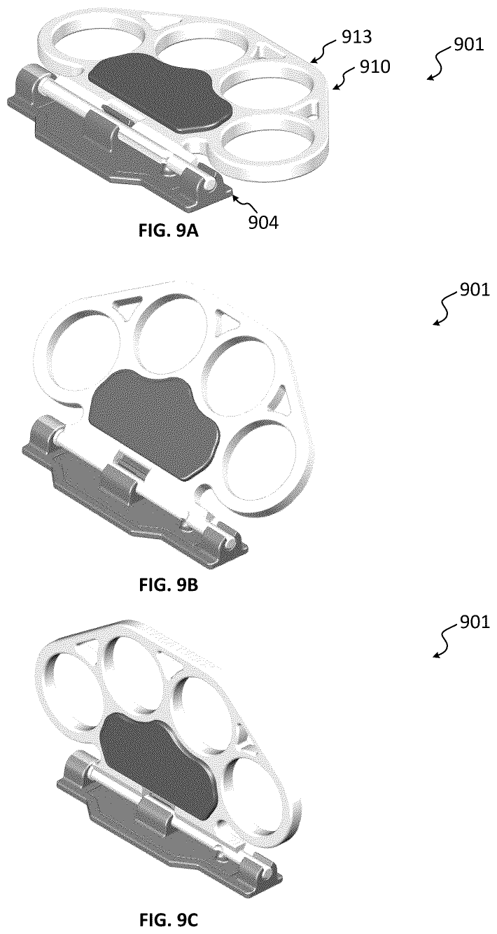

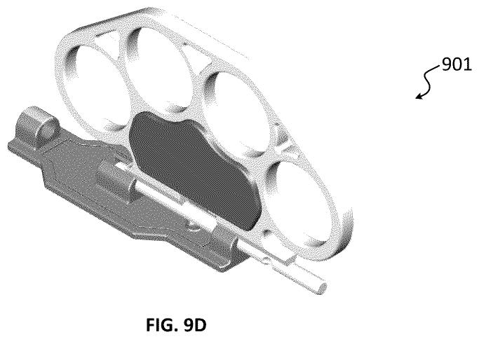

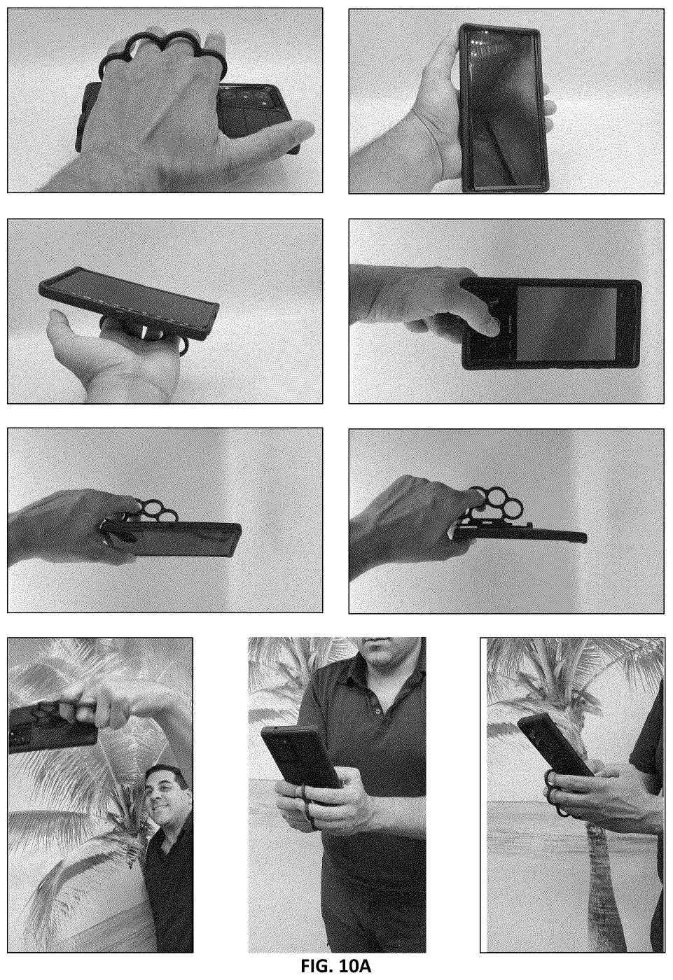

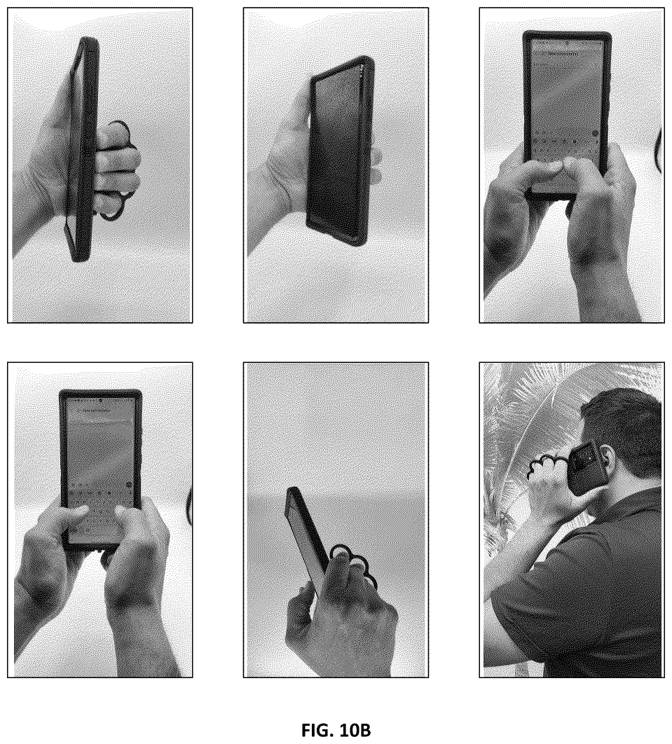

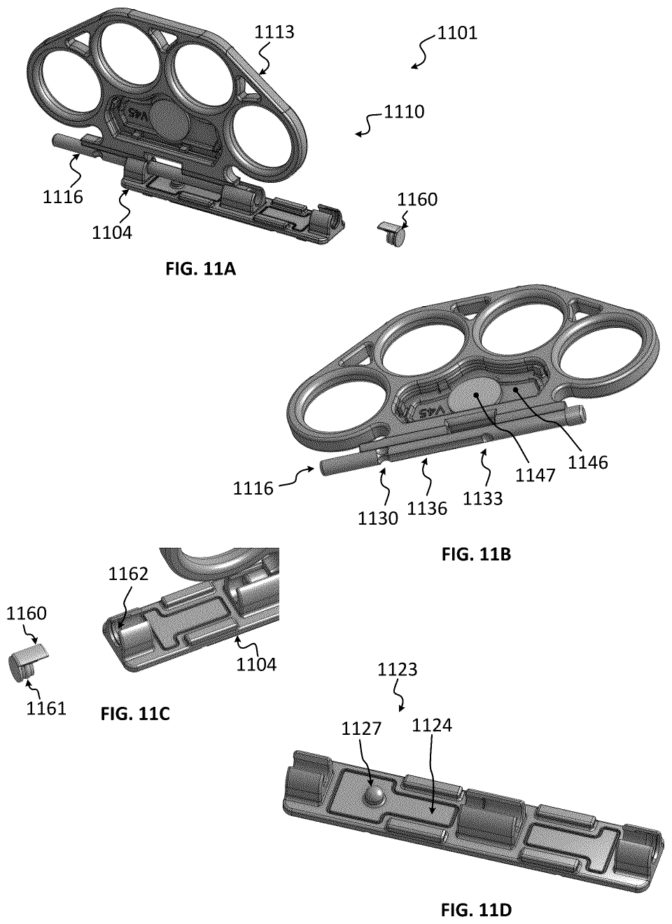

FIG. 8A is a side view of another exemplary embodiment of a device.

FIG. 8B illustrates radial cross-sections of the exemplary device shown in FIG. 8A.

FIG. 8C is an enlarged view of portions of the radial cross-sections shown in FIG. 8B.

FIGS. 8D-8G are longitudinal sections of the device shown in FIG. 8A, with the handle at various positions relative to the base.

FIG. 9A illustrates an exemplary device with its grip disposed parallel to a plane of its base.

FIG. 9B illustrates the device of FIG. 9A with its grip disposed at approximately 45 degrees relative to a plane of its base.

FIG. 9C illustrates the device of FIG. 9A with its grip disposed at approximately 90 degrees relative to plane of the base.

FIG. 9D illustrates the device of FIG. 9A with its grip disposed at approximately 90 degrees relative to the base and with the grip laterally translated.

FIGS. 10A-10B illustrate exemplary devices in use in various positions and applications.

FIGS. 11A-11D illustrate another exemplary embodiment of a device.

### DETAILED DESCRIPTION

The present disclosure may be understood more readily by reference to the following description and the accompanying figures. It is to be understood that this disclosure is not limited to the specific devices, conditions or parameters described and shown herein, and that the terminology used herein is for the purpose of describing particular embodiments by way of example only, rather than to limit the scope.

The exemplary embodiments of a device include a handle and grip (sometimes referred to collectively hereinafter as simply “a grip”) for a mobile communication device. In some embodiments, a device is provided for securely supporting a device, for example, a mobile communication device, including a smartphone. In some embodiments, the device includes a grip including one or more openings configured for receiving and engaging one or more of a user's fingers or the user's palm. In some embodiments, the one or more finger openings engage a base that is secured to a back side of a device or a device case with, for example, adhesive. The grip may be configured to enable a user to comfortably and securely hold the mobile communication device while a hand of the user is in a natural, outstretched orientation. In some embodiments, the grip is configured to enable the user to have secure and full control of the mobile communication device during use, reducing the risk of a user dropping the mobile communication device.

In some embodiments, the grip provides provides a user with ergonomic dexterity for operating the mobile communication device while the grip is in a fixed lower cradle orientation. In a stow orientation, the grip may be collapsed such that it is flush with the back of the mobile communication device. In some embodiments, the grip reduces stress, strain, and long-term deformation of a user's fingers or thumbs, which may protect against or minimize development of arthritis in a user. In some embodiments, the grip is configured such that a user is not required to stretch or bend any finger or wrist outside of a normal range of motion to support the mobile communication device during use.

In some embodiments, a portion of the device forms a kickstand or holder. In some embodiments, the device includes a handle and grip including one or more finger openings that engage a base. In some embodiments, the combination of the one or more finger openings and the base form a hinge. In some embodiments, the grip is configured for fixed engagement with a case that includes a business card holder or a wallet pouch or sleeve. In some embodiments, the grip is fixed to a center of a case; in other embodiments, the grip is integrated with a case; in still other embodiments, the grip is secured to the mobile communication device itself. In some embodiments, the grip in a kickstand configuration can be adjusted at an angle relative to the mobile communication device to provide comfort for the user and stability for the mobile communication device during use. In some embodiments, the grip is configured as a kickstand for the mobile communication device such that the mobile communication device can be positioned on a surface, for example, a table, and the mobile communication device can be viewed at a selected angle. In some embodiments, the kickstand is configured as either a horizontal or vertical kickstand.

In some embodiments, a device is provided for securely supporting a mobile communication device. The device may include a grip having one or more finger openings that engage a base. In some embodiments, the grip is configured for fixed engagement with a case that includes a wallet configured for holding, for example, business cards, credit cards or identification cards. In some embodiments, the device is configured as a mount for use in a vehicle such that the mobile communication device can be operated in a hands-free configuration. In some embodiments, the device is configured to facilitate or simplify the taking of selfie pictures.

As used in herein, the singular forms “a,” “an,” and “the” may include the plural, and a reference to a particular numerical value may include at least that particular value, unless the context clearly dictates otherwise. Ranges may be expressed herein as from “about” or “approximately” one particular value to “about” or “approximately” another particular value. When such a range is expressed, an embodiment may include the particular specified values. Similarly, when values are expressed as approximations, by use of the antecedent “about,” it will be understood that the particular value forms another embodiment. In general, any reference to “about” or “approximately” may mean within 1%, or 5%, or 10%, or 20%, or 50% of a nominal value. “Substantially” may mean within 99%, 95%, 90%, 80% or 50% of a nominal value. “Slight” or “slightly” may mean modification of a nominal value or state by 1%, 5%, 10% or 20%. Spatial references, such as, for example, horizontal, vertical, top, upper, lower, bottom, left and right, are for illustrative purposes only and can be varied within the scope of the disclosure. For example, the references “upper” and “lower” or “top” and “bottom” are relative and used only in the context of the other.

The following discussion includes a description of a grip for securely supporting a device, for example, a mobile communication device, including a smartphone and/or a tablet. Alternate embodiments are also disclosed. Reference will now be made in detail to the exemplary embodiments of the present disclosure, which are illustrated in the accompanying figures.

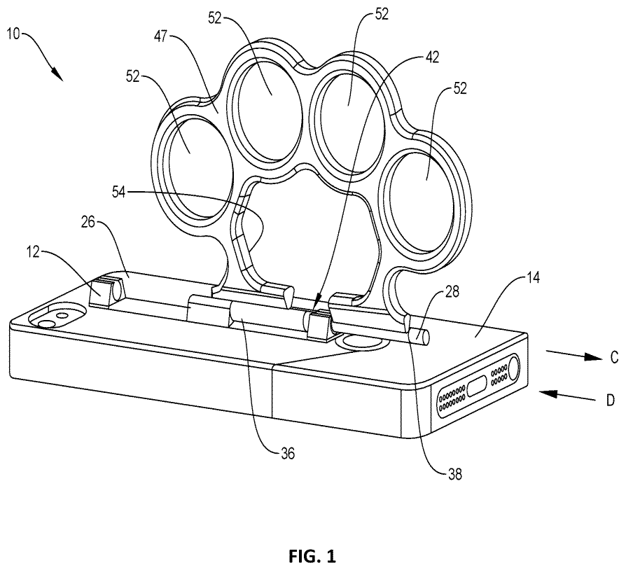

Turning to FIGS. 1-6, there are illustrated components of a grip device 10. As shown in FIG. 1, grip 10 includes a base, for example, a bracket 12, that is connectable with a mobile communication device 14. In some embodiments, the mobile communication device 14 includes, for example, a cellphone, smartphone, personal digital assistant, or a tablet computer. Bracket 12 may include a proximal end 16 and a distal end 18 and may be characterized by a longitudinal axis AA. Bracket 12 may have various cross-section configurations, for example, arcuate, cylindrical, oblong, rectangular, polygonal, undulating, irregular, uniform, non-uniform, consistent, variable, and/or U-shape. In some embodiments, bracket 12 may have alternate surface configurations, for example, rough, undulating, porous, semi-porous, dimpled, polished or textured.

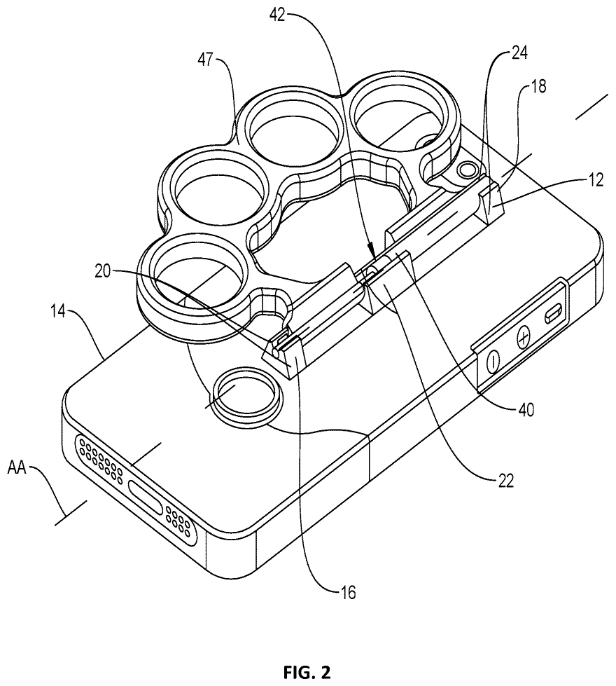

As shown in FIG. 2, bracket 12 includes sets of spaced apart channels 20, 22, 24. Channels 20, 22, 24 may define a longitudinal cavity, for example, slot 26, as shown in FIG. 1. Slot 26 may be configured to receive a longitudinal member (e.g., shaft 28) that is movably disposable within slot 26. Channels 20, 22, 24 may have various cross-section configurations, for example, arcuate, cylindrical, oblong, rectangular, polygonal, undulating, irregular, uniform, non-uniform, consistent, variable, and/or U-shape. In some embodiments, channels 20, 22, 24 have alternate surface configurations, for example, rough, undulating, porous, semi-porous, dimpled, polished and/or textured. In some embodiments, channels 20, 22, 24 are configured as knuckles of a hinge, as described herein.

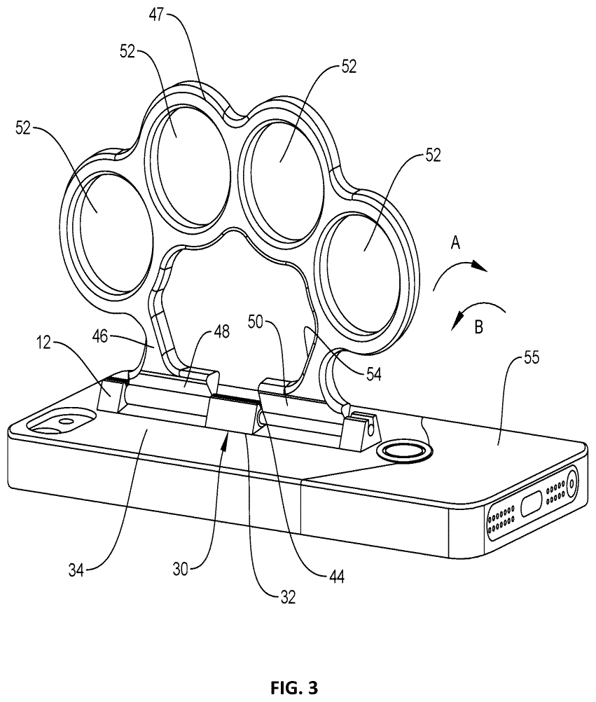

As shown in FIG. 3, bracket 12 may include a surface 30 that defines a bottom 32 that is configured for fixed engagement with a surface 34 of mobile communication device 14. In some embodiments, bottom 32 is fixed to surface 34 via adhesive. In some embodiments, bottom 32 is fixed to surface 34 via hook-and-loop fasteners, snaps, buttons, hooks, mutual grooves, screws, adhesive, barbs, raised elements, spikes, clips, friction fittings, compression fittings, expanding rivets, fixation plates, keys/keyslots, tongue-and-groove couplings, dovetail couplings, magnetic connections, posts, etc.

As shown in FIG. 2, shaft 28 may include a first end 36 and a second end 38, and it may be characterized by longitudinal axis AA. Shaft 28 may have various cross-section configurations, for example, arcuate, cylindrical, oblong, rectangular, polygonal, undulating, irregular, uniform, non-uniform, consistent, variable, and/or U-shape. In some embodiments, shaft 28 has alternate surface configurations, for example, rough, undulating, porous, semi-porous, dimpled, polished or textured.

A magnet 42 may be disposed on a surface 40 of shaft 28. Magnet 42 may be configured for engagement with another magnet 44 disposed with channel 22, as shown in FIG. 3 (e.g., to fix or lock shaft 28 with slot 26 in a selected orientation). When shaft 28 is fixed within slot 26, shaft 28 may be rotatable at a selected angle relative to bracket 12. In some embodiments, magnet 42 has a positive side exposed and magnet 44 has a negative side exposed. In some embodiments, shaft 28 and channel 22 alternatively include snaps, mutual grooves, clips, friction fittings, compressive fittings, keys/keyslots, tongue-in-groove connections, or dovetail connections.

Shaft 28 may include a surface 46 that defines a body 47, as shown in FIG. 1. Body 47 may be configured for engagement with a user's hand for gripping such that mobile communication device 14 can be supported by the user. In some embodiments, body 47 can be regular, irregular, freeform-shaped, or three-dimensional. In some embodiments, body 47 may have alternate surface configurations, for example, rough, undulating, porous, semi-porous, dimpled, polished and/or textured to facilitate a grip by the user.

As shown in FIG. 3, body 47 includes spaced apart portions 48 and 50. Portions 48 and 50 may be configured for engagement with channels 20, 22, 24 to form a hinge configuration with bracket 12. In some embodiments, portions 48, 50 can be knuckles of a hinge.

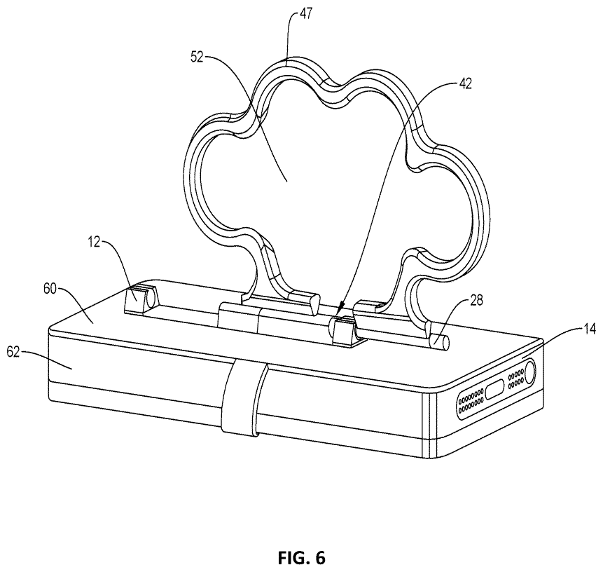

As shown in FIGS. 1-3, body 47 may define finger openings 52 configured for engagement with fingers of a user to facilitate supporting of mobile communication device 14. Openings 52 may enable a user to comfortably and securely support the mobile communication device 14 while a hand of the user is in a natural outstretched orientation. Openings 52 may be disposed adjacent relative to each other. Openings 52 are shown as circular; but in other embodiments, openings 52 can be variously configured, including nonagon, octagon, heptagon, hexagon, triangle, scalene triangle, right triangle, parallelogram, rhombus, square, pentagon, oval, heart, cross, arrow, cube, cylinder, star, crescent, a wavy line, semicircular, ring and/or quatrefoil shaped. In some embodiments, openings 52 can be regular, irregular and/or freeform shaped. In some embodiments, openings 52 may have alternate surface configurations, for example, rough, undulating, porous, semi-porous, dimpled, polished and/or textured to facilitate a grip by the user. In some embodiments, grip 10 may include one or a plurality of openings 52. As shown in FIG. 6, grip 10 alternatively includes a single opening 52.

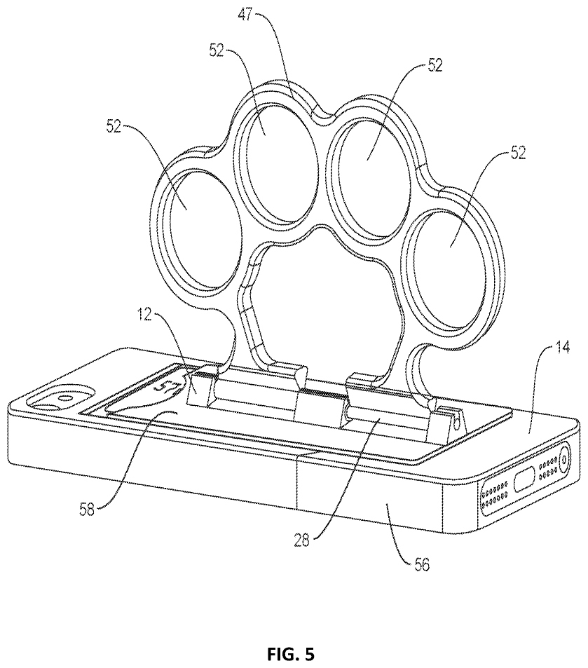

Surface 46 may define an open bridge 54 disposed inferior relative to openings 52. Bridge 54 may be configured for engagement with a palm of a user to facilitate supporting of mobile communication device 14. In some embodiments, bridge 54 can be variously configured, including circular, nonagon, octagon, heptagon, hexagon, triangle, scalene triangle, right triangle, parallelogram, rhombus, square, pentagon, oval, heart, cross, arrow, cube, cylinder, star, crescent, a wavy line, semicircular, ring and/or quatrefoil shaped. In some embodiments, bridge 54 can be regular, irregular and/or freeform shaped. In some embodiments, bridge 54 may have alternate surface configurations, for example, rough, undulating, porous, semi-porous, dimpled, polished and/or textured to facilitate a grip by the user. In some embodiments, grip 10 may include one or a plurality of bridges 54. As shown in FIG. 5, grip 10 alternatively includes openings 52 without a bridge 54.

As shown in FIG. 2, shaft 28 is slidably disposable within slot 26 and rotatable about longitudinal axis AA. Shaft 28 may be rotatable at a selected angle relative to bracket 12 such that the user can place grip 10 in a selected orientation when supporting mobile communication device 14.

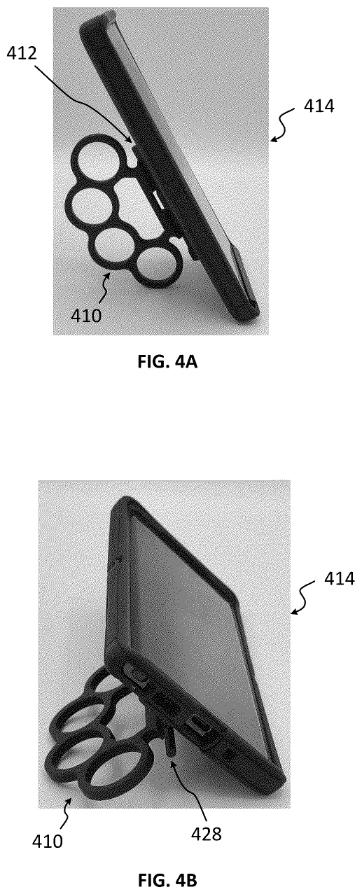

As shown in FIGS. 4A and 4B, shaft 428 and grip 410 can be selectively fixed at an angle relative to bracket 412 to form a stand configuration for mobile communication device 414. In the stand configuration, the mobile communication device 414 can be placed on a surface and oriented in an angled upright position vertically (FIG. 4A) or horizontally (FIG. 4B).

In some embodiments, shaft 28 is slidably disposable within slot 26 such that shaft 28 can be disconnected from bracket 12. In some embodiments, shaft 28 can be disconnected from bracket 12 to interchange multiple embodiments of grip 10 with bracket 12. In some embodiments, bracket 12 includes a case 55 for mobile communication device 14, as shown in FIG. 3. In some embodiments, bracket 12 is integrated with the case.

In use, the grip 10 may enable the user to comfortably and securely support the mobile communication device 14 while a hand of the user is in an outstretched orientation. In some embodiments, grip 10 is configured to enable the user to have secure and full control of mobile communication device 14 during use (e.g., when the user is texting or taking a selfie); and this configuration may reduce the risk of the user dropping the mobile communication device 14. The user may engage body 47 of grip 10 and may orient fingers of a hand through openings 52. The palm of the user may engage the bridge 54. The user may rotate body 47 of grip 10 in different directions—as shown by arrows A and B in FIG. 3—to adjust the angle in which that body 47 of grip 10 is oriented. For example, body 47 of grip 10 may be rotated in the direction shown by arrow A to place body 47 of grip 10 into a cradle orientation, as shown in FIG. 2 (e.g., to facilitate texting by the user). In a cradle orientation, body 47 of grip 10 may be collapsed and engaged with surface 34 of mobile communication device 14.

To remove shaft 28 from mobile communication device 14, shaft 28 may be translated in a direction, as shown by arrow C in FIG. 1, such that shaft 28 translates through slot 26 until shaft 28 disengages from bracket 12. In some embodiments, to engage shaft 28 with bracket 12, the shaft 28 may be translated in a direction, as shown by arrow D in FIG. 1, such that shaft 28 translates through slot 26 until magnet 42 of shaft 28 engages with magnet 44 of bracket 12, fixing shaft 28 with bracket 12.

In one embodiment, as shown in FIG. 5, bracket 12 includes a case 56 that includes a business card holder 58. In one embodiment, as shown in FIG. 6, bracket 12 includes a case 60 that includes a wallet 62 configured for engagement with mobile communication device 14 and is implemented to store items including, for example, credit cards, business cards, social security cards, and/or money. The cases shown in FIGS. 5 and 6 are merely exemplary—the principles and methods described herein could be applied to various styles of case, holder skin, etc. Moreover, while specific styles of mobile communication device are illustrated and described, the principles and methods described herein could be more broadly applied to tablets, computing devices and other mobile communication devices.

FIGS. 7A-7D illustrate another embodiment of an exemplary device 701. As shown in FIG. 7A, the device 701 includes a base 704 that may be coupled to a mobile communication device (not shown). The base 704 may include an anchor system that includes a first-end anchor 707a, a second-end anchor 707b and a middle anchor 707c.

The device 701 further includes a handle 710 having a grip 713 and a shaft 716. The grip 713 may be coupled to the shaft 716 at two spaced-apart portions 718a and 718b. In some embodiments, the shaft 716 is a cylindrical shaft; in other embodiments, the shaft 716 may take other cross-sectional forms. Regardless, the shaft 716 may be characterized by a longitudinal axis 719.

In the embodiment shown in FIG. 7B, the first-end anchor 707a includes a first channel 720a; the second-end anchor 707b includes a second channel 720b; and the middle anchor 707c includes a middle channel 720c. Each of the first channel 720a, the second channel 720b and middle channel 720c may be coaxial with a longitudinal anchor axis 722. In some embodiments (e.g., as shown in FIG. 7B), shaft 716 has a uniform diameter along its length; and each of the first channel 720a, second channel 720b and middle channel 720c has a common diameter that accommodates the shaft 716. In other embodiments (e.g., as shown in FIGS. 8D-8G), a diameter of the shaft 716 may vary along its length, and diameters of the first channel 720a, second channel 720b and middle channel 720c may also vary (e.g., to each only accommodate a portion of the shaft 716).

The shaft 716 may also include one or more recesses that are configured to be releasably engaged with a detent mechanism 723, which may include a spring member 724 and a detent 727. The spring member 724 may bias the detent 727 toward the longitudinal anchor axis 722. In some embodiments, the detent 727 is hemispherical in shape and configured to releasably engage corresponding recess(es)—which are now described.

As shown, the shaft 716 includes a plurality of recesses 730 disposed along a common circumference of the shaft 716. One or more additional recesses (e.g., recess 733) may also be disposed away from the plurality of recesses 730. Moreover, a recessed channel 736 may also be provided. With such an arrangement, the detent mechanism 723 may cooperate with one or more recesses (e.g., recesses 730, recess 733 or recessed channel 736) to releasably fix the handle 710 at an angle relative to the base 704. For example, when the grip 713 is disposed as shown in FIG. 7A, it may be releasably fixed at 90 degrees relative to a plane corresponding to the bottom of the base 704 (as shown). Alternatively, in embodiments in which there are a plurality of circumferentially disposed recesses (e.g., recesses 730), the grip may be fixed at other angles relative to the plane corresponding to the bottom of the base 704 (e.g., 0 degrees (or “flush” with the base 704, as shown in FIG. 7C), 30 degrees, 45 degrees, 90 degrees, 120 degrees, 135 degrees, 150 degrees, or some other angle). Moreover, in embodiments in which one or more additional recesses (e.g., recess 733 or recessed channel 736) are disposed away from the plurality of recesses 730, the handle 710 may be releasably fixed with the handle translated away from the first-end anchor 707a (e.g., in a position in which the shaft 716 is disposed only in the middle anchor 707c and to the second-end anchor 707b, as shown in FIG. 7D).

As with other embodiments described herein, the grip 710 may include discrete finger openings 740 and a palm opening 743. With reference to FIG. 7D, an insert 746 may be provided to close off the palm opening 743 and/or to provide a surface for indicia, such as a customized logo 749. In such embodiments, the device 701 may be employed, at least in part, as marketing collateral for the entity or person. Moreover, the insert 746 may be one of many possible inserts, each having a different color, texture, logo, or other indicia, etc. In some embodiments, one or more inserts may be provided with the device 701, for example, to enable individual users to customize the device 701. For example, in some embodiments, one or more of a red insert, yellow insert, blue insert, black insert, white insert, etc., may be provided. In some embodiments, insert 746 may be snap-fit into the palm opening 743 (e.g., with cooperating fixing means 747, such as nubs in the palm opening 743 and corresponding recesses or notches in the insert 746), such that it can be removed or replaced. In other embodiments, the insert 746 may be secured in the palm opening 743 with an adhesive or other means in a more permanent or semi-permanent manner. In some embodiments, the insert 746 may further include a magnet (e.g., for securing the device 701 to a mount) or a radio frequency identification (RFID) or near field communication (NFC) chip (e.g., to provide further identification, payment or security features).

In embodiments such as those just described, the device may provide an ergonomic grip configuration to enable a user of a mobile device to which the device 701 is attached to grasp the mobile device or mobile device case or skin. For example, a configuration such as the one shown in FIG. 7A may provide a “stand” for the mobile device to be supported on a flat surface; or alternatively, such a configuration may enable a user to comfortable grasp the mobile device with one hand (e.g., while the user is viewing content on a corresponding mobile device (not shown) to which the device 701 is coupled). As another example, a configuration such as the one shown in FIG. 7D may enable a user of the mobile device to comfortably text (e.g., using a dynamic touch-screen keyboard near the “bottom” of the screen of a mobile device when the mobile device is in a “portrait” orientation). In particular, embodiments in which the second-end anchor is disposed nearest the above-referenced “bottom” end of a corresponding screen, the position of the grip 710 as shown in FIG. 7D may accommodate a user's fingers in such a way as to minimize stress on the user's thumbs while texting—while providing the user with a secure grip of the corresponding mobile device. Configurations, positions, and advantages are contemplated beyond those that are illustrated in or described with reference to FIG. 7A or FIG. 7D. For example, as the reader will appreciate, recesses that are configured to engage the detent mechanism 723 may be disposed at various other points on the shaft 716.

The detent mechanism 723 itself may take various forms. As illustrated in FIG. 7B, it may include a spring member 724 and a detent member (e.g., a hemispherical member 727, as shown, in some embodiments). The spring member 724 may bias the detent member 727 toward the longitudinal anchor axis 722, so as to engage a corresponding recess (e.g., recess 730, recess 733 or recessed channel 736) in the shaft 716 when that recess and the detent are aligned, but enable the detent to flex away from the shaft 716 as it is translated away from a recess. In some embodiments, the spring member 724 is a portion of the material of the base 704 that has been separated on three sides from the base 704.

In other embodiments, the recesses and detent may take different forms. For example, the detent may comprise a pin, and the recess with which the pin engages may take the form of a hole or a groove. The spring member 724 may be an integral part of the base 704, as shown in FIG. 7B; or the spring member 724 may be a separate component (e.g., a compression spring and a ball bearing or pin). In some embodiments, magnets may supplement or replace the recesses (e.g., recesses 730, 733 and 736) and the detent 727. Other variations are contemplated and will be apparent to the reader.

FIGS. 8A-8H illustrate another embodiment of a device 801. FIG. 8A is a side view of the base 804 with its anchor members, including a first-end anchor 807a, second-end anchor 807b, and middle anchor 807c; and the handle 810 with its grip 813 and shaft 816 coupled to the grip 813 at spaced-apart portions 818a and 818b. In this embodiment, a diameter of the shaft 816 varies over its length, as will now be described.

FIG. 8B illustrates radial cross-sections taken along each of the section lines A-A, B-B, C-C, G-G and H-H shown in FIG. 8A. FIG. 8C illustrates enlarged radial cross-sections of the shaft 816 at various points along its length, and corresponding cross-sections of channels in the first-end anchor 807a (sections A-A; detail D), in the second-end anchor 807b (section H-H; detail K), in the middle anchor 807c (section C-C; detail F and section G-G; detail J), and between the first-end anchor 807a and the middle anchor 807c (section B-B; detail E).

As shown (see, in particular, FIG. 8D), the diameter of the shaft 816 varies along its length. For example, the shaft 816 may have a first diameter 850 along a first portion 851 and a second diameter 853 along a second portion 854. In embodiments such as the one shown, the first diameter 850 may be greater than the second diameter 853, and channel size may vary accordingly. For example, the first-end anchor 807a may have a first channel 820a that has a diameter 821a that is slightly larger than the corresponding first diameter 850 of the first portion 851 of the shaft 816; similarly, the second-end anchor 807b may have a second channel 820b that has a diameter 821b that is slightly larger than the corresponding second diameter 853 of the second portion 854 of the shaft 816.

In some embodiments, a middle channel 820c may be segmented—for example, into a first segment 824a having a first-segment diameter 823a and a second segment 824b having a second-segment diameter 823b. The first-segment diameter 823a may be similarly dimensioned as diameter 821a—such that it accommodates the first portion 851 of the shaft 816; and the second-segment diameter 823b may be similarly dimensioned as diameter 821b—such that it accommodates the second portion 854 of the shaft 816. In other embodiments, the first segment 824a and second segment 824b may be differently dimensioned. In still other embodiments, the middle anchor 807c may not be segmented but instead may have a uniform diameter.

In some segmented embodiments, the second segment 824b does not accommodate the first portion 851 of the shaft 816 (e.g., the diameter 823b may be smaller than the diameter 850); in such embodiments, design of the middle anchor 807c prevents the handle 810 from being translated beyond a point at which it is anchored by the middle anchor 807c and second-end anchor 807b. Such designs, may allow the handle 810 to be translated within a predefined range. For example, such embodiments may facilitate translation of the handle 810 from the position shown in FIGS. 8E and 8F to the position shown in FIG. 8G—but not beyond the position of FIG. 8G (that is, translation of the handle 810 away from the first-end anchor 807a may be prevented beyond a point at which the middle anchor 807c engages at least the first portion 851 of the shaft 816).

Translation of the handle 810 in an opposite direction may also be limited. For example, a cap 860 (see FIG. 8F) may be disposed in an opening in the first-end anchor 807a that otherwise accommodates the first portion 851 and second portion 854 of the shaft 816. In other embodiments, a cap may take a different form or be differently disposed. See, for example, element 760 in FIGS. 7A, 7C and 7D.

Turning to FIGS. 8D-8H, additional details are described. As depicted in FIG. 8D, the device 801 may be assembled by sliding the handle 810 into the base 804, starting from the first-end anchor 807a. As the handle 810 is slid into the base 804, the shaft 816 engages the first-end anchor 807a and middle anchor 807c (see FIG. 8E). A longitudinal axis 819 of the shaft 816 may be coaxial with the longitudinal anchor axis 822.

As shown in FIG. 8F, further translation of the handle 810 into the base 804 causes the second-end anchor 807b to engage the shaft 816, and, in some embodiments as shown, a detent 827 to engage a corresponding recess 830, causing the handle 810 to be releasably fixed relative to the base 804. The cap 860 may then be installed in the first-end anchor 807a, as shown in FIG. 8F, to prevent the handle 810 from being translated back out of the first-end anchor 807a, away from the middle anchor 807c.

Further translation out of the first-end anchor 807a toward the middle anchor 807c may be possible (depending on dimensions of the first diameter 850, the second diameter 853 and the diameters of the first channel 821a, second channel 821b, and middle channel 820c). In particular, a force, F, applied in the direction indicated (see FIG. 8F), may overcome the holding force of the detent 827 and recess 830, causing the detent 827 and its corresponding spring member 824 to flex away from the recess 830, such that the shaft 816 can be further translated (e.g., along a recessed channel 836, in some embodiments, when the handle 810 is positioned normal to the base 804).

In some embodiments, as described above, translation may be limited by dimensions of the shaft 816. For example, the first diameter 850 may be larger than the diameter 823b of the second segment 824b of the middle channel 807c. An additional recess 833 may engage with the detent 827 to releasably fix the portion of the handle as shown in FIG. 8G, In some embodiments, position is fixed both laterally and radially. In some embodiments, the recesses 830 and 833 may be hemispherical in shape, the recessed channel 836 may be cylindrical in shape (e.g., substantially shaped as a longitudinal segment of a cylinder), and the corresponding detent 827 may be hemispherical in shape. In some embodiments, position may be fixed only laterally. The recesses 830 and 833 may be annular rings, and the detent 827 may be hemispherical in shape. In some embodiments, the shaft 816 may include a plurality of hemispherical recesses disposed along a circumference, such that the handle 810 can be releasably fixed laterally and at a plurality of different radial angles relative to the base 804 (e.g., as described with reference to the embodiments illustrated in FIGS. 7A-7D).

The detent 827 and recesses 830 and 833 may take forms other than hemispheres, including, for example, that of a pin and hole, a tab and groove, a tab and annular ring, etc. The cap 860 may be press-fit or secured with an adhesive and may take form other than shown (e.g., it may be cylindrical and close only a portion of the first channel (as depicted in FIGS. 8F and 8G), or it may also close off a portion of a slot at the top of the first channel (as depicted in FIGS. 7A and 7B). In some embodiments, all or a portion of grip 10 and/or components of case 55, 56 and/or 60 is made from a material including, for example, plastic, chromed or coated plastic, flexible plastic, steel, stainless steel, aluminum, fabric, leather, patent-leather, silicone, and/or rubber.

FIGS. 9A-9D illustrate another embodiment of an exemplary device 901 having a base 904, a handle 910, and a grip portion 913 of the handle 910. As shown, the grip portion 913 has a different shape than other embodiments illustrated herein. FIG. 9A illustrates the device 901 with the grip 913 disposed parallel to a plane of the base 904. FIG. 9B illustrates the device 901 with the grip 913 disposed at approximately 45 degrees relative to a plane of the base 904. FIG. 9C illustrates the device 901 with the grip 913 disposed at approximately 90 degrees relative to plane of the base 904. FIG. 9D illustrates the device 901 with the grip 913 disposed at approximately 90 degrees relative to the base 904 and with the grip 913 laterally translated relative to its position in FIGS. 9A-9C.

FIGS. 10A-10B illustrate exemplary devices in use in various positions and applications (e.g., demonstrating general gripping, facilitating photographs of the user, facilitating texting and messaging applications, demonstrating ergonomic grips in various positions, etc.).

FIGS. 11A-11D illustrate another embodiment of an exemplary device 1101. As shown in FIG. 11A, the device 1101 includes a base 1104 that may be coupled to a mobile communication device (not shown). As shown, the base 1104 includes an anchor system that is similar to other embodiments illustrated and described herein; a handle 1110 having a grip 1113 and a shaft 1116. A cap 1160 may retain the handle 1110/grip 1113/shaft 1116 in the base 1104 after it is inserted therein.

As shown in more detail in FIG. 11C, the cap 1160 may include a raised sealing region 1161 (or, in some embodiments, a separate gasket) that may cooperate with a receiving end 1162 on the base 1104; in particular, the sealing region 1161 and the receiving end 1162 may form a compression fit that keeps the cap 1160 tightly coupled to the base 1104.

As with other embodiments, and as shown in FIG. 11B, the shaft 1116 may also include one or more recesses that are configured to be releasably engaged with a detent mechanism 1123 (see FIG. 11D), which detent mechanism may include a spring member 1124 and a detent 1127. The spring member 1124 may bias the detent 1127 toward longitudinal anchor axis of the shaft 1116.

As shown, the shaft 1116 includes a plurality of recesses 1130 disposed along a common circumference of the shaft 1116. One or more additional recesses (e.g., recess 1133) may also be disposed away from the plurality of recesses 1130. Moreover, a recessed channel 1136 may also be provided. With such an arrangement, the detent mechanism 1123 may cooperate with one or more recesses (e.g., recesses 1130, recess 1133 or recessed channel 1136) to releasably fix the handle 1110 at an angle relative to the base 1104.

The grip 1110 may include discrete finger openings and a palm opening, and an insert 1146 may be provided to close off the palm opening or to provide a surface for indicia, such as a customized logo. In some embodiments, the insert 1146 may further include a magnet 1147 (e.g., for securing the device 701 to a mount) or a radio frequency identification (RFID) or near field communication (NFC) chip (e.g., to provide further identification, payment or security features).

Several embodiments have been described with reference to exemplary aspects, but it will be understood by those skilled in the art that various changes may be made and equivalents may be substituted for elements thereof without departing from the contemplated scope. For example, the methods and principles described herein may be applied to various devices, such as, for example, mobile communication devices, tablets, computing devices, etc. Attachment may be made to devices themselves directly, or to cases or skins for such devices. Some handles may include a single opening for palm and fingers; other handles may provide discrete openings for four fingers; other handles may provide discrete openings for four fingers and a separate palm opening.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended.

What is claimed is:

1. A device comprising:
a base configured to be coupled to a mobile communication device, the base including a detent mechanism;
a handle comprising a grip and a shaft, the shaft characterized by (i) a longitudinal handle axis, (ii) a first portion having a first diameter, (iii) a second portion having a second diameter that is different than the first diameter, and (iv) at least one recess configured to be releasably engaged with the detent mechanism; and
a plurality of anchors comprising a first-end anchor, a second-end anchor and a middle anchor; the first-end anchor having a first channel that accommodates the first diameter, the second-end anchor having a second channel that accommodates the second diameter, and the middle anchor having a middle channel; each of the first channel, second channel and middle channel being coaxial with a longitudinal anchor axis;
wherein the first channel, second channel and middle channel accommodate the shaft and allow it to be slidably translated along and rotated about the longitudinal anchor axis and longitudinal handle axis between a first orientation, in which the handle and grip are rotated flush with the base; and a second orientation that is different than the first orientation, in which the handle and grip are releasably fixed, through engagement of the detent mechanism and the at least one recess, at an angle relative to the base.

2. The device of claim 1, wherein the first diameter is greater than the second diameter; the second-end channel accommodates the second diameter but not the first diameter; and the the middle channel comprises two segments, including a first segment that accommodates the first diameter and a second segment that accommodates the second diameter but not the first diameter.

3. The device of claim 1, further comprising a cap configured to be inserted into an end of the first channel, such that when the shaft is disposed in the first channel, middle channel and second channel, and the cap is inserted into the end of the first channel, the cap prevents translation of the shaft away from the middle anchor and past the cap.

4. The device of claim 1, further comprising a plurality of recesses disposed along a common circumference that is also common to the at least one recess, each of the recesses in the plurality of recesses configured to be releasably engaged with the detent mechanism to releasably lock the handle and grip at a corresponding plurality of angles relative to the base.

5. The device of claim 4, further comprising at least one additional recess disposed away from the plurality of recesses and also configured to be releasably engaged with the detent mechanism to releasably lock the handle and grip at an angle relative to the base when the grip and handle are translated away from the first-end anchor such that the shaft is retained only by the middle anchor and the second-end anchor.

6. The device of claim 5, further comprising a recessed channel coupling the at least one recess and the at least one additional recess.

7. The device of claim 6, wherein the recessed channel is shaped substantially as a longitudinal segment of a cylinder.

8. The device of claim 1, wherein the detent mechanism comprises an interlocking element disposed on a spring member, wherein the spring member biases the interlocking element toward the longitudinal anchor axis.

9. The device of claim 8, wherein the interlocking element is a hemispherical element; and the at least one recess is a hemispherical recess configured to engage with the hemispherical element.

10. The device of claim 1, wherein the handle is selectively fixed at an angle relative to the base to form a stand.

11. The device of claim 1, wherein the grip comprises four finger openings disposed adjacent to each other.

12. The device of claim 11, wherein the grip further comprises a palm opening between the four finger openings and the shaft.

13. The device of claim 12, further comprising an insert that is configured to be removably attached to the grip and close the palm opening.

14. The device of claim 12, wherein the insert comprises a magnet.

15. The device of claim 12, wherein the insert comprises at least one of a radio frequency identification (RFID) tag or a near-field communication (NFC) device.

16. The device of claim 1, wherein the base comprises a case for the mobile communication device.

17. The device of claim 1, wherein the base comprises a surface having an adhesive configured to adhere to a portion of the mobile communication device.

18. The device of claim 1, wherein the base includes a wallet that is configured to retain business cards, credit cards and/or identification cards.

19. A device comprising:
a base configured to be coupled to a mobile communication device, the base including a detent mechanism;
a handle comprising a grip and a shaft, the shaft characterized by (i) a longitudinal handle axis, (ii) a first portion having a first diameter, (iii) a second portion having a second diameter that is different than the first diameter, and (iv) at least one recess configured to be releasably engaged with the detent mechanism; and
a plurality of anchors comprising a first-end anchor, a second-end anchor and a middle anchor; the first-end anchor having a first channel that accommodates the first diameter, the second-end anchor having a second channel that accommodates the second diameter, and the middle anchor having a middle channel; each of the first channel, second channel and middle channel being coaxial with a longitudinal anchor axis;
wherein the first channel, second channel and middle channel accommodate the shaft and allow it to be slidably translated along and rotated about the longitudinal anchor axis and longitudinal handle axis; and wherein the grip comprises four finger openings disposed adjacent to each other and a palm opening between the four finger openings and the shaft.

20. The device of claim 19, wherein the detent mechanism comprises an interlocking element disposed on a spring member, wherein the spring member biases the interlocking element toward the longitudinal anchor axis.
